(19) United States
(12) Patent Application Publication
(10) Pub. No.: US 2009/0121513 A1
(43) Pub. Date: May 14, 2009

(54) Visor and Method for Making a Visor

(75) Inventor: Kirk J. Olep, Hudsonville, MI (US)

Correspondence Address: FOLEY AND LARDNER LLP;SUITE 500, 3000 K STREET NW, WASHINGTON, DC, 20007, US

(73) Assignee: Johnson Controls Technology Company

(21) Appl. No.: 11/990,430

(22) PCT Filed: Aug. 10, 2006
(86) PCT No.: PCT/US2006/031184

§ 371 Date: Feb. 14, 2008

Related U.S. Application Data
(60) Provisional application No. 60/709,326, filed on Aug. 18, 2005.

(51) Int. Cl. B60J 3/02; B29C 45/14

(52) U.S. Cl. 296/97.1; 264/242

(57) ABSTRACT

A visor assembly includes a first core pad facially secured to a second core pad by a plurality of first connecting members of the first core pad engaging a plurality of second connecting members on the second core pad. A frame is secured to at least one of the first core pad and the second core pad. A cover material covers the exterior of the first core pad and the second core pad and is secured by a plurality of retention members. The retention members are located on an interior surface of at least one of the first core pad and the second core pad.

### CROSS-REFERENCE TO RELATED PATENT APPLICATIONS

This Application claims the benefit of U.S. Provisional Application No. 60/709,326, filed Aug. 18, 2005, the content of which is incorporated herein by reference in its entirety.

### BACKGROUND

The present invention relates generally to a visor for use in vehicles and a method for making such a visor. More specifically, the present invention relates to visors for vehicles (or other applications) having a core made from a first material and inserted molded with structural elements formed from a second material. The present invention more particularly relates to a visor formed of a lightweight material with structural elements or inserts that facilitate a tucked edge fabric appearance for use with any of a wide variety of different vehicles.

Visors for use in vehicles to shield an occupant from sunlight are generally known. Such visors typically have a “butterfly” or “clamshell” type core portion made from a material such as cardboard or polypropylene with generally symmetrical halves that connect together to form a joint or seam about a perimeter edge of the visor. The visors may be at least partially covered by a cover material such as a fabric that often “overlaps” or is wrapped over the perimeter edges of the core portion so that when the core portion is “folded” about a midpoint, the perimeter edges of each half of the core portion meet to form an outwardly extending peripheral seam and the cover material is tucked therebetween to create a “tucked edge” appearance.

However, such known visors tend to have certain disadvantages. For example, when the two halves of the visor core are formed from a lightweight material such as expanded polypropylene (EPP), the body of the visor tends to lack a desired structural rigidity. Further, the creation of a “tucked edge” appearance from a cover material along the visor perimeter tends to involve time and labor intensive activities such as gluing, sewing, or stapling the cover material along an inside edge of two EPP core halves that are then joined together (like a “sandwich”) to form a desired tucked edge appearance of the cover material along the sides and bottom of the visor perimeter.

Accordingly, it would be desirable to provide a visor having a core made from a lightweight material and having a cover material with a tucked edge along the perimeter. It would also be desirable to provide a visor having an EPP core that is capable of quickly and securely retaining a cover material to create a tucked edge appearance. It would also be desirable to provide a visor having two EPP core pads that are capable of retaining a portion of the cover material therebetween. It would also be desirable to provide structural elements that are formed into the core pads for retaining the cover material and/or for joining and connecting the core pads together and/or for strengthening the visor and/or for supporting accessories provided in the visor (such as vanities, mounting hardware, illumination devices, remote control devices, ticket clips, slide mechanisms, extender panels or visor ears, etc). It would also be desirable to provide a visor having structural elements that are insert-molded into the core halves to facilitate rapid assembly of the visor components into a finished product. It would be further desirable to provide a method for making a visor that quickly and conveniently captures a cover material between the core pads during assembly of the visor to provide a tucked edge appearance.

Accordingly, it would be desirable to provide a visor and method for making a visor having any one or more of these or other advantageous features.

### SUMMARY

One embodiment of the invention relates to a visor assembly. The visor assembly includes a first core pad facially secured to a second core pad by a plurality of first connecting members on the first core pad engaging a plurality of second connecting members on the second core pad. A frame is secured to at least one of the first core pad and the second core pad. A cover material covers the exterior of the first core member and the second core member and is secured by a plurality of retention members, the plurality of retention members being located on an interior surface of at least one of the first core pad and the second core pad.

Another embodiment of the invention relates to a visor assembly having a first core section facially secured to a second core section via a plurality of opposing pads located on the interior surfaces of the first core section and the second core section. A frame is secured within a channel in at least one of the first core section and the second core section, and a cover material covers the exteriors of the first core section and the second core section. A portion of the cover material is secured between the first core section and the second core section by projections located on an interior surface of at least one of the first core section and the second core section.

Yet another embodiment of the invention relates to a method of making a visor assembly. The method includes providing a plurality of visor connecting components, providing a mold for formation of a first core pad and a second core pad, and positioning the plurality of connecting components within the mold. The method further includes the steps of injecting a material into the mold and around the plurality of components to form the first core pad and the second core pad, wrapping a cover material around the first core pad and the second core pad such that at least a portion of the cover material extends beyond the peripheral edges of the first core pad and the second core pad, and facially securing the first core pad and the second core pad with the portion of the cover material secured therebetween using the connecting components.

Yet another embodiment of the invention relates to a visor assembly having a first core section with at least one first melt pad upstanding from the interior surface of the first core section. A second core section has at least one second melt pad upstanding from the interior surface of the second core section and positioned at a facially opposing position to the first melt pad. The visor assembly also includes a frame secured to at least one of the first core section and the second core section, and a cover material covering at least a portion of the exterior surfaces of the first core section and the second core section. The cover material is secured between the interior surfaces of the first core section and the second core section, and the first melt pad is joined to the second melt pad, thereby securing the first core section to the second core section.

The invention is capable of other embodiments and of being practiced or being carried out in other ways. Alternative exemplary embodiments relate to other features and combinations of features as may generally be recited in the claims.

### BRIEF DESCRIPTION OF THE DRAWINGS

FIG. 1 is a perspective view of a visor according to an exemplary embodiment;

FIG. 2 is a sectional view of section 2-2 of the visor of FIG. 1 according to an exemplary embodiment;

FIG. 3 is an exploded view of a visor according to an exemplary embodiment;

FIG. 4 is a perspective view of a portion of the visor of FIG. 3 according to an exemplary embodiment;

FIG. 5 is a front view of a core portion of a visor in an open configuration according to an exemplary embodiment;

FIG. 6 is an exploded view of a portion of a visor according to an exemplary embodiment; and

FIG. 7 is a block diagram of a method of making a visor according to an exemplary embodiment.

### DETAILED DESCRIPTION

The FIGURES illustrate exemplary embodiments of a component or assembly such as a visor for use in vehicles (e.g., automobiles such as cars, trucks, SUVs; buses; recreational vehicles and the like; airplanes; boats; etc.). Such visors may be provided in a wide variety of sizes, shapes, materials, and configurations according to various exemplary embodiments. According to the illustrated embodiments, a visor may have generally rigid structural elements integrally formed into (or placed or “fit” within suitable recesses or receptacles formed in) lightweight core pads (e.g., EPP core pads) that may be folded or otherwise joined together to form the visor body and retain a cover material therebetween in a single operation, to minimize the need for additional time-consuming operations to create a tucked edge appearance. The structural elements may be molded into the core pads and operate to hold the cover material edges between the peripheral edges of the core pads and to hold the core pads together. Many variations of the illustrated embodiments may be made by persons of ordinary skill in the art. Accordingly, all such variations and alternatives are intended to be within the scope of the embodiments described herein.

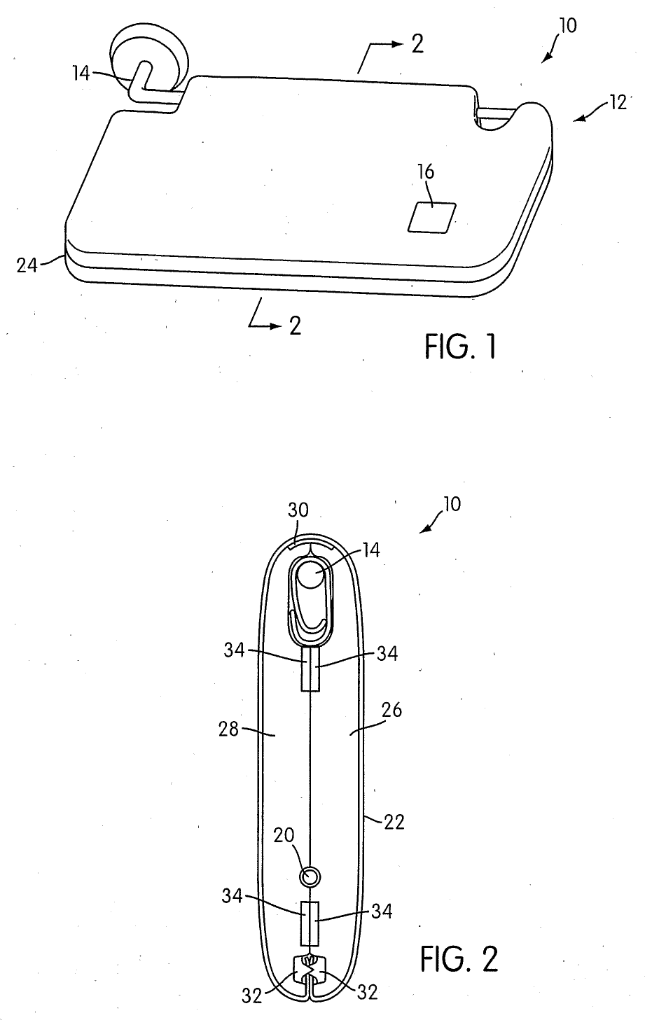

Referring to FIG. 1, a visor 10 according to an exemplary embodiment is shown. Visor 10 includes a visor body 12 and an attachment structure 14. Attachment structure 14 is used to attach visor 10, for example, to a vehicle. Visor 10 may optionally include an accessory 16 (e.g., a vanity, a compartment, a ticket holder, etc.). Visor 10 may be a visor having a lightweight core and insert-molded structural elements for use with a cover material (e.g. fabric, vinyl, leather, etc.) in a tucked edge arrangement as shown according to an exemplary embodiment.

Referring to FIGS. 2-5, visor body 12 is shown in greater detail according to an exemplary embodiment. Body 12 is shown to include two core pads 26, 28 (e.g. panels, halves, etc.) formed from a generally lightweight material, such as a foam, EPP, or other formable lightweight material suitable for use as a visor body to provide a finished visor product with reduced overall weight (in comparison with visors made from more traditional and heavier materials). Core pads 26, 28 are shown as formed in a “butterfly” or “clamshell” configuration that may be “folded” about a top edge 38, 40 of each core pad 26, 28 to form visor body 12. Top edges 38, 40 of each core pad 26, 28 may be joined by a structural element in the form of a flexible hinge member 30, or core pads 26, 28 may be interconnected by a web or bridge of the core material intended to bend or break when the pads are folded together during visor assembly. Core pads 26, 28 may be molded in a suitable size and shape for use in any particular visor program. For example, core pads 26, 28 may have any desirable outline shape, recesses for mounting brackets or Euro-pins, internal recesses or cutouts for accommodating accessories such as accessory 16 (e.g., vanities, illumination devices, remote control devices, electrical conductors and connectors, etc.) or structural elements, etc.

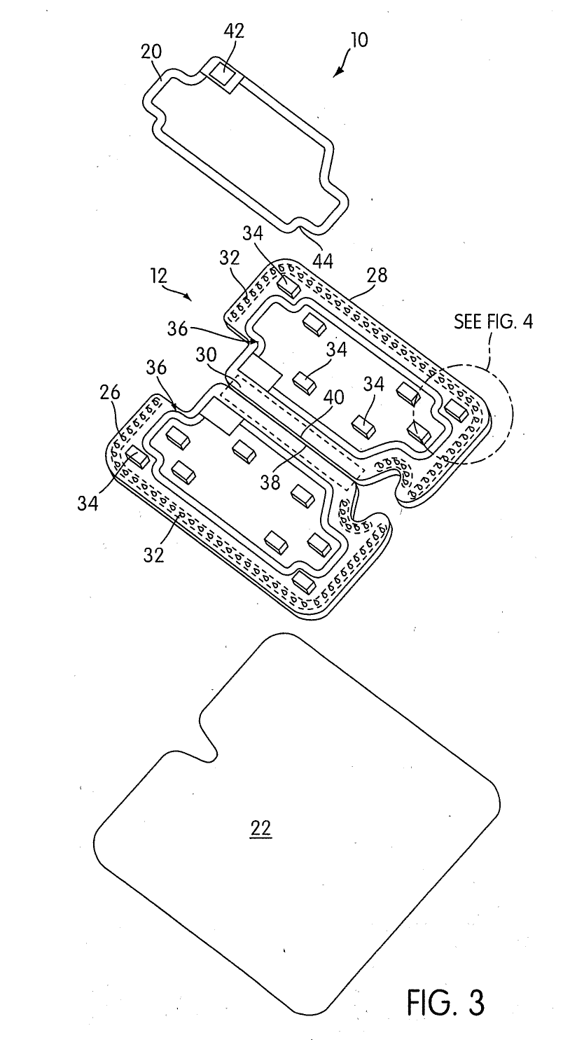

Referring to FIG. 3, according to an exemplary embodiment, visor 10 may also include a frame member 20 (intended to add rigidity, strength and/or robustness to the visor body) that may be formed from any suitable material such as plastic or metal (e.g. wire, etc.) and so on. Frame member 20 may be insert-molded within one of the core pads 26, 28, or may be separately positioned (e.g. by sonic welding, melting into the lightweight core pad material, gluing, press-fit, etc.) within a suitable recess, receptacle or channel, shown as channel 36, on an interior surface of one of core pads 26, 28 prior to assembling visor 10. Frame member 20 is also shown to include mounting structure 42 for mounting visor 10, such as a sleeve or tube configured to receive a visor pivot rod, detent spring, mounting bracket and/or slide mechanism (not shown). Frame member 20 is also shown to be contoured in a desired shape to accommodate other components of visor 10. For example as shown along the corners of visor 10, frame member 20 has inset portions 44 that are intended to create “seal zones” where one or more core connecting members 34 on core pads 26, 28 interface with one another to couple core pads 26, 28 securely together to form visor body 12 with a cover material 22 tucked between a number of opposing cover retainer members 32 to create a tucked edge 24 (see FIG. 1). Frame member 20 may also include other components and/or accessories.

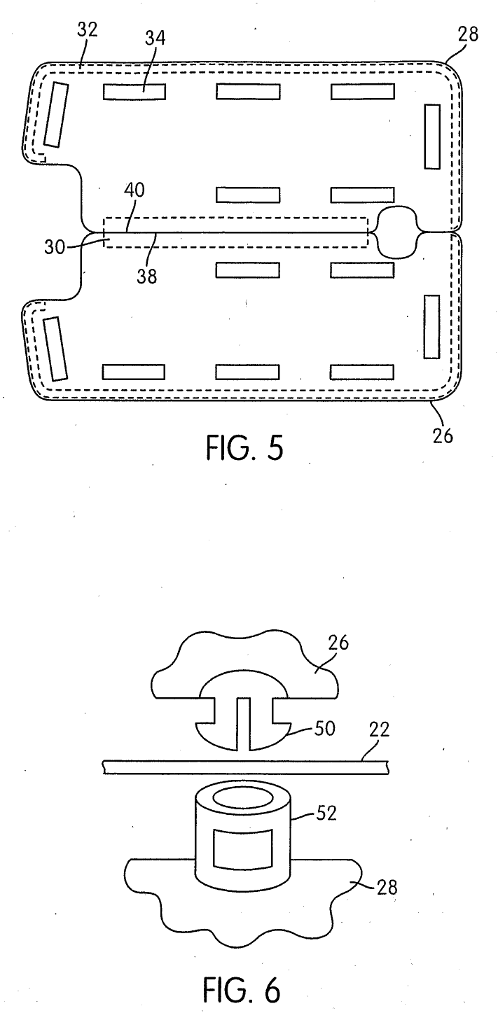

Referring to FIGS. 2, 3, and 5, visor body 12 includes a hinge member 30, such as a relatively thin panel made from plastic or polymer and having a crease, groove or the like to act as a flexible “living hinge” according to an exemplary embodiment. Hinge member 30 is shown to be insert-molded along top peripheral edges 38, 40 of each core pad so that the visor body may be assembled by “folding” core pads 26, 28 together about the “living” hinge member (see FIG. 5). According to an alternative embodiment, hinge member 30 may be separately attached to core pads 26, 28 (e.g. by sonic welding, melting into the lightweight core pad material, gluing, press-fit, etc). Hinge member 30 may also have certain contours so that it forms a desired shape when core pads 26, 28 are folded together. For example, the panel of hinge member 30 may be curved or have complimentary recesses arranged to form a tube, channel, or other structure when core pads 26, 28 are joined together, so that the tube or channel provides structure for receiving visor mounting or sliding components such as a pivot rod, detent spring, slide mechanism or the like for movably coupling visor 10 to a vehicle. According to alternative embodiments, hinge member 30 may be omitted in favor of a web or bridge of material formed between core pads 26, 28 that bends or breaks when core pads 26, 28 are folded together, or core pads 26, 28 may be physically independent from one another for assembly in any suitable manner.

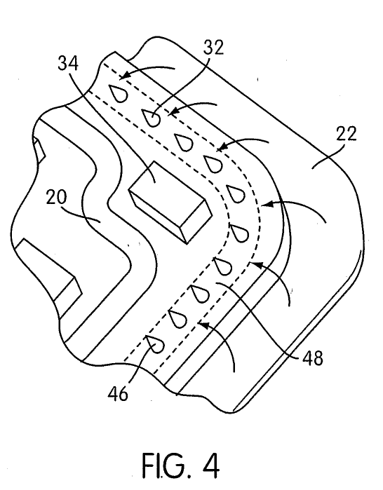

According to an exemplary embodiment, visor 10 also includes cover retention members 32 that may be integrally formed (e.g., insert-molded, etc.) into the core pads. Cover retention members 32 (e.g., shark's teeth, ridges, hooks, projections, etc.) are shown by way of example as a series of ridge-like or cone-shaped projections 46 (see FIG. 4), referred to by way of example as “shark's teeth,” on each core pad 26, 28 that are sized and shaped to capture and hold (e.g., trap, secure, etc.) cover material 22 that has been wrapped around the side and bottom peripheral edges of core pads 26, 28 when the core halves are joined together to form a tucked edge appearance. The shark's teeth are formed on strips, shown as strip 48, that may be insert molded within core pads 26, 28 along their side and bottom peripheral edges. Note, however, that the shark's teeth may also be arranged along top peripheral edges 38, 40 of core pads 26, 28 for embodiments that do not use hinge member 30 or the like. According to an alternative embodiment, cover retention members 32 may be separately attached to core pads 26, 28 (e.g., by sonic welding, melting into the lightweight core pad material, gluing, press-fit, etc). Cover retention members 32 may have any suitable size and shape (e.g., hooks, pins, frictional materials, etc.) intended to capture and retain a tucked edge 24 (see FIG. 1) of the fabric when core pads 26, 28 are assembled together.

Further referring to FIGS. 2-5, visor 10 also includes core connecting members 34 according to an exemplary embodiment. Core connecting members 34 (e.g., ribs, pads, plates, hooks, interlocking tabs and apertures, etc.) are shown as “melt pads” integrally formed with core pads 26, 28 from the lightweight material of core pads 26, 28 and are located on each core pad 26, 28 to align with one another when the core pads are joined together and are coupled to one another using any suitable process such as sonic welding, melting, heat plate application, glue, etc. According to an alternative embodiment, connecting members 34 may be formed from any suitable material such as a plastic or polymer that is integrally formed (e.g., insert-molded, etc.) with core pads 26, 28 so that connecting members 34 may be connected (e.g., fused, welded, sealed, melted, etc.) using a process such as heat plate melting, sonic welding, etc. after core pads 26, 28 have been placed together. Core connecting members 34 may alternatively be mechanically fastened together, e.g., in the case of interlocking tabs and apertures. Core connecting members 34 may be located at any suitable location on core pads 26, 28 to provide effective coupling of core pads 26, 28 and a secure retention of cover material 22 between the opposing shark's teeth 46 on core pads 26, 28.

Referring to FIG. 6, according to an alternative embodiment, core connecting members 34 may be provided in the form of interlocking members (e.g. tabs/slots, male/female connectors, snap-fit, interference fit, compression fit, or other suitable type of interlocking connectors) formed along the interior surfaces of core pads 26, 28 and arranged for mutual engagement. According to another alternative embodiment, core connecting members 34 may be integrated with cover retention members 32. For example, projections 50 and corresponding receptacles 52 may be provided on core pads 26, 28 and configured to both interconnect core pads 26, 28 and trap or capture cover material 22 therebetween.

Cover material 22 is shown for example as a separate layer that is applied to the exterior surface of core pads 26, 28 and tucked therebetween as the core pads are joined and fastened together (see FIG. 3). According to alternative embodiments, the cover material may be pre-formed on the exterior of core pads 26, 28, such as by using mold-behind technology during formation of core pads 26, 28, so that cover material 22, core pads 26, 28, and other structural elements are all formed in a minimum number of operations.

According to various exemplary embodiments, visor 10 is provided having a lightweight core with integrally formed structural elements that receive an edge of cover material 22 and secure core pads 26, 28 together with cover material 22 therebetween to create a neat tucked edge appearance (see, e.g., tucked edge 24 shown in FIG. 1). Core pads 26, 28 and various structural elements may also be configured to accommodate or interface with other visor components and accessories (e.g. vanity lamps, map lamps, reading lamps, conversation lamps, etc.); storage devices such as “ticket clips,” pen/pencil holders, resilient retainer straps, etc.; storage compartments or bins (e.g. hinged, sliding, etc.) for items such as coin holders, etc.; internal pockets, such as for containing articles such as remote control devices, etc.

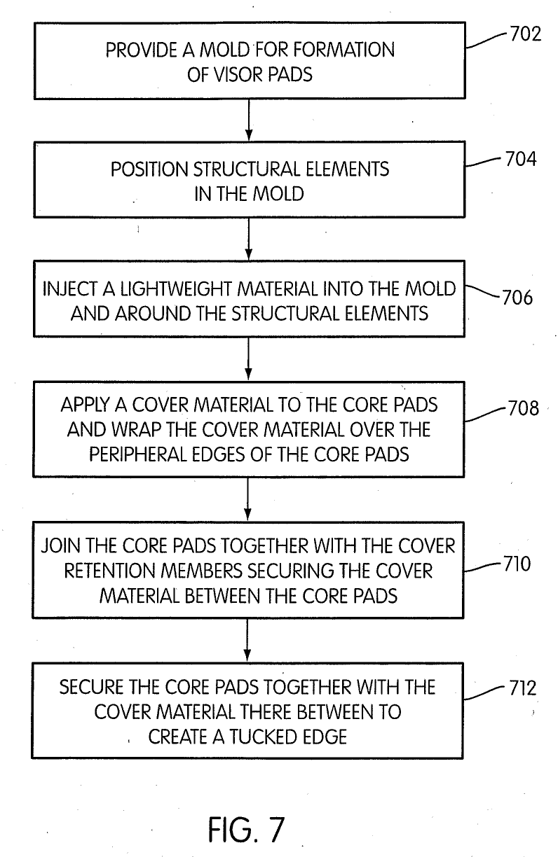

Referring to FIG. 7, according to an exemplary embodiment, a method of making a visor (e.g., visor 10) is disclosed and includes providing a mold (such as a cavity for injection molding that may include mold-behind capability for a cover material) for formation of visor pads (e.g., core pads 26, 28) for an intended vehicle visor (step 702). The pads may be formed from any suitable material, preferably as lightweight material such as EPP, foam or the like. Structural elements (e.g., frame member 20, hinge member 30, core connecting members 34, cover retention members 32, etc.) are placed at suitable locations within the mold (step 704) such that they may be integrally formed (e.g., insert-molded, etc.) with the core pads. A lightweight material (e.g., EPP) is injected into the mold cavity(ies) to form the core pads with the structural elements formed therein (step 706). A cover material (such as cover material 22, a fabric, leather, vinyl, etc.) is applied to at least a portion of the exterior surfaces of the core pads and wrapped (or otherwise drawn around) at least the side and peripheral edges of the core pads (step 708). The core pads are joined together so that the cover retention members secure the cover material therebetween (step 710) and the core pads are secured in relation to one another by interconnecting (e.g. fusing, melting, welding, snap-connecting, frictionally engaging, etc.) the core connecting members (which may be shapes formed from the lightweight material of the core pads, or other material inserted into the core pads) to create a tucked edge (step 712). According to these and various other embodiments, other components may be attached to the visor such as accessories and mounting devices to suit an intended application (see, e.g., component 16 shown in FIG. 1).

The construction and arrangement of the elements of the visor and method for making a visor as shown in the illustrated and other exemplary embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited herein (e.g., the structural elements may be formed from any suitable material and may be integrated with the core pads using any suitable process, the core pads may be formed from any suitable material and the core pads may be joined together in the closed configuration using any suitable structure, material, compound or method). For example, elements shown as integrally formed may be constructed of multiple parts or elements, the position of elements may be reversed or otherwise varied, and the nature or number of discrete elements or positions may be altered or varied (e.g. the core connecting members, hinge members, frame member and/or cover retention members may be provided in any suitable shape, size, and location, or may be combined with one another in any suitable combination). It should be noted that the elements and/or assemblies of the visor may be constructed from any of a wide variety of materials that provide sufficient strength or durability, including any of a wide variety of moldable plastic materials (such as high-impact plastic), or foams, polymers, etc. and in any of a wide variety of colors, textures, and combinations. Other substitutions, modifications, changes, and omissions may be made in the design, operating conditions, and arrangement of the preferred and other exemplary embodiments without departing from the scope of the present invention(s).

The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes, and omissions may be made in the design, operating configuration, and arrangement of the preferred and other exemplary embodiments without departing from the spirit of the present invention(s) as expressed in the appended claims.

What is claimed is:

1. A visor assembly, comprising:
a first core pad facially secured to a second core pad by a plurality of first connecting members on the first core pad engaging a plurality of second connecting members on the second core pad;
a frame secured to at least one of the first core pad and the second core pad; and
a cover material covering the exterior of the first core pad and the second core pad and secured by a plurality of retention members, the retention members being located on an interior surface of at least one of the first core pad and the second core pad.

2. The visor assembly of claim 1, further comprising:
a hinge connecting an edge of the first core pad to an edge of the second core pad.

3. The visor assembly of claim 2, wherein the first core pad, the second core pad, and the hinge are an integrally formed component.

4. The visor assembly of claim 3, wherein the first core pad and the second core pad comprise an expanded polypropylene material and the hinge comprises a plastic material.

5. The visor assembly of claim 2, wherein the hinge is a flexible material that breaks when the first core pad is secured to the second core pad.

6. The visor of claim 1, wherein the plurality of first connecting members and the plurality of second connecting members are melt pads located at facially opposing locations on the first core pad and the second core pad.

7. The visor of claim 1, wherein the plurality of first connecting members are one of projections and receptacles configured to engage the plurality of second connecting members being the other one of projections and receptacles.

8. The visor of claim 1, wherein the retention members are projections.

9. The visor of claim 8, wherein the projections are secured to at least one elongated strip, the at least one elongated strip being secured to at least one of the first core pad and the second core pad.

10. The visor of claim 1, wherein the plurality of first connecting members and the plurality of second connecting members comprise the retention members, each of at least a portion of the plurality of first connecting members and the plurality of second connecting members acting both to secure the first core pad to the second core pad and to secure a portion of the cover material between the first core pad and the second core pad.

11. The visor of claim 1, wherein the first core pad and the second core pad comprise an expanded polypropylene material and the frame comprises a plastic material.

12. A visor assembly, comprising:
a first core section facially secured to a second core section via a plurality of opposing pads located on the interior surfaces of the first core section and the second core section;
a frame secured within a channel in at least one of the first core section and the second core section; and
a cover material covering the exteriors of the first core section and the second core section, a portion of the cover material being secured between the first core section and the second core section by projections located on an interior surface of at least one of the first core section and the second core section.

13. The visor assembly of claim 12, wherein corresponding pairs of the facially opposing pads are melted together.

14. The visor assembly of claim 12, further comprising:
a hinge securing an edge of the first core section to an edge of the second core section.

15. The visor assembly, of claim 12, wherein the frame is metal.

16. The visor assembly of claim 12, wherein the projections are mounted to at least one strip, the at least one strip being secured to at least one of the first core section and the second core section.

17. The visor assembly of claim 16, wherein the projections are upward pointing conical projections.

18. The visor assembly of claim 12, wherein the first core section and the second core section comprise expanded polypropylene.

19. A method of making a visor, comprising:
providing a plurality of visor connecting components;
providing a mold for formation of a first core pad and a second core pad;
positioning the plurality of connecting components within the mold;
injecting a material into the mold and around the plurality of connecting components, thereby forming the first core pad and the second core pad;
wrapping a cover material around the first core pad and the second core pad such that at least a portion of the cover material extends beyond the peripheral edges of the first core pad and the second core pad; and
facially securing the first core pad to the second core pad with the portion of the cover material secured therebetween using the connecting components.

20. The method of claim 19, further comprising:
inserting a frame member between the first core pad and the second core pad prior to facially securing the first core pad to the second core pad.

21. The method of claim 20, wherein the material is an expanded polypropylene and the frame comprises a plastic material.

22. The method of claim 19, wherein the plurality of connecting components include melt pads for facially securing the first core pad to the second core pad.

23. The method of claim 19, wherein the plurality of connecting members include projections mounted on at least one strip for securing the portion of the cover material between the first core pad and the second core pad, and wherein positioning the plurality of components within the mold includes placing the at least one strip within the mold such that the projections extend upward from an interior surface of at least one of the first core pad and the second core pad after forming the first core pad and the second core pad.

24. The method of claim 19, further comprising:
positioning a hinge within the mold with the connecting components, such that upon injecting the material into the mold an edge portion of the first core pad is secured to an edge portion of the second core pad.

25. The method of claim 19, wherein the material is expanded polypropylene.

26. The method of claim 25, wherein the connecting components comprise a plastic material.

27. A visor assembly, comprising:
a first core section having at least one first melt pad, the first melt pad upstanding from the interior surface of the first core section;
a second core section having at least one second melt pad, the second melt pad upstanding from the interior surface of the second core section, the second melt pad being positioned at a facially opposing position to the first melt pad;
a frame secured to at least one of the first core section and the second core section; and
a cover material covering at least a portion of the exterior surfaces of the first core section and the second core section, the cover material being secured between the interior surfaces of the first core section and the second core section;
wherein the first melt pad is joined to the second melt pad, thereby facially securing the first core section to the second core section.
